(19) United States
(12) Patent Application Publication
(10) Pub. No.: US 2007/0024198 A1
(43) Pub. Date: Feb. 1, 2007

(54) Gas discharge lamp

(75) Inventor: Josephus Christiaan Maria Hendricx, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/571,818

(22) PCT Filed: Sep. 10, 2004
(86) PCT No.: PCT/IB04/51738

§ 371 Date: Mar. 15, 2006

(30) Foreign Application Priority Data
Sep. 17, 2003 (EP) 03103413.5

(51) Int. Cl. H01J 61/30

(52) U.S. Cl. 313/634; 313/622; 445/26; 313/623

(57) ABSTRACT

A discharge lamp comprising an elongated discharge vessel, preferably made of a ceramic material, surrounded by an outer envelope and having a wall which encloses a discharge space containing an inert gas and an ionizable filling, wherein at both ends in said discharge space an electrode is arranged between which a discharge arc can be maintained along a discharge path, wherein one end of the discharge vessel is mounted in a mounting base, said lamp comprising a lead-back conductor supplying current from the mounting base to the electrode at the other end of the discharge vessel, characterized in that the lead-back conductor extends through the length of the wall of the outer envelope.

The invention relates to a gas discharge lamp comprising an elongated discharge vessel, preferably made of a ceramic material, surrounded by an outer envelope and having a wall which encloses a discharge space containing an inert gas and an ionizable filling, wherein at both ends in said discharge space an electrode is arranged between which a discharge arc can be maintained along a discharge path, wherein one end of the discharge vessel is mounted in a mounting base, said lamp comprising a lead-back conductor supplying current from the mounting base to the electrode at the other end of the discharge vessel.

Such lamps are known, and the lead-back conductor is usually a wire running at some distance from the outer envelope. In such lamps electrical contact is possible between the back lead wire and the reflector or metal shield which avoids light beams passing to unwanted areas. To avoid contact with the metal shield or reflector a sufficiently large distance must be created. But even when a distance is present, arcing is possible between the wire and the reflector or shield, due to high voltage pulses. Due to the larger dimensions of the lamp that are required therefore, there is a loss of flux in the beam pattern of the lamp. Further the invention aims at a lamp having smaller dimensions in general.

In order to solve said problem the lead-back conductor is provided inside the wall of the outer envelope. Voltage breakthrough between the lead wires supplying current to the electrodes is prevented thereby, and the whole lamp is isolated from the environment. There is thus no shock hazard in case of lamp mounting or after a car collision. Overall the invention provides a more compact lamp, and results in flux gain in the beam pattern.

The lead back conductor may be mounted in a hollow channel, for instance a bored tubular hole in the wall of the outer envelope. This is not difficult to realise, since the wall may have a relatively large thickness of about 2 mm, which is necessary to lower the maximum temperature of the discharge vessel and homogenize the upper and lower wall temperatures of the horizontally burning lamp.

It is also possible to provide a hollow channel in the wall of the outer envelope by quartz extrusion. This allows for non-circular tubes and lead-back conductors, such as elliptical or strip-like forms. After inserting the back lead conductor in the hollow channel and connecting the lead-back conductor with the feed through and the electrode in the discharge vessel the end wall of the outer envelope is closed for instance by melting, pressing or by a combination thereof.

Preferably the hollow channel is provided with a dark or black light absorbing coating. Thereby light scattering of the walls of the hole is avoided.

Preferably the lead back conductor, the light-absorbing strip and/or the antenna are provided with a dark or black light absorbing coating, in order to prevent light scattering.

In automotive lamps a band-shaped light-shielding strip usually extends along the length of the discharge vessel as a light absorbing coating on the wall of either the discharge vessel or the outer envelope. The light-shield achieves a light/dark boundary, which is projected many times by the multi-facet lens of the headlight assembly or by a so called “free form reflector” such that a sufficiently sharp beam delineation in the beam pattern of the headlight is provided in order to avoid radiation of light giving rise to dazzle, for example. Just below the light/dark-boundary in a dimmed beam pattern there must be a very high light intensity to lighten a road at a distance, whereas just above said light/dark boundary a very low light intensity must be present to avoid said dazzle. This is called the cut-off, which must be sharp, and in many countries must comply with prescribed standards.

Some lamp types also comprise a conductive antenna extending laterally from the discharge path. The conductive antenna in such lamps usually extends along the length of the discharge vessel between electrodes and serves as a so-called ignition strip or starting antenna. The antenna capacitively couples the high voltage pulse from an electrode, through the gas filling and the wall, to the antenna, and finally to the other electrode. This reduces the apparent distance between electrodes and therefore increases the applied electric field which accelerates primary electrons and initiates the so-called Townsend avalanche. This occurs when at least one secondary electron is emitted in the gas filling for each primary electron, and the discharge current becomes self-sustaining.

The invention also relates to a vehicle head lamp comprising a reflector and a gas discharge lamp as described above mounted therein.

Furthermore the invention relates to a method for producing a gas discharge lamp wherein an elongated discharge vessel having a wall which encloses a discharge space containing an inert gas and an ionizable filling is provided, wherein at both ends in said discharge space an electrode is arranged between which a discharge arc can be maintained along a discharge path, wherein a lead-back conductor is provided for supplying current from a mounting base wherein one end of the discharge vessel will be mounted to the electrode at the other end of the discharge vessel, wherein an outer envelope is provided, wherein the electrode at said other end of the discharge vessel is connected to said lead-back connector, and wherein an outer envelope is provided for surrounding said discharge vessel, characterized in that a hollow channel is provided in the length of the wall of the outer envelope, and the lead-back conductor is inserted in said hollow channel and the discharge vessel is inserted in the outer envelope, after which the outer envelope is closed.

The above and further aspects of the lamp in accordance with the invention will now be explained with reference to lamp embodiments shown in the figures, wherein:

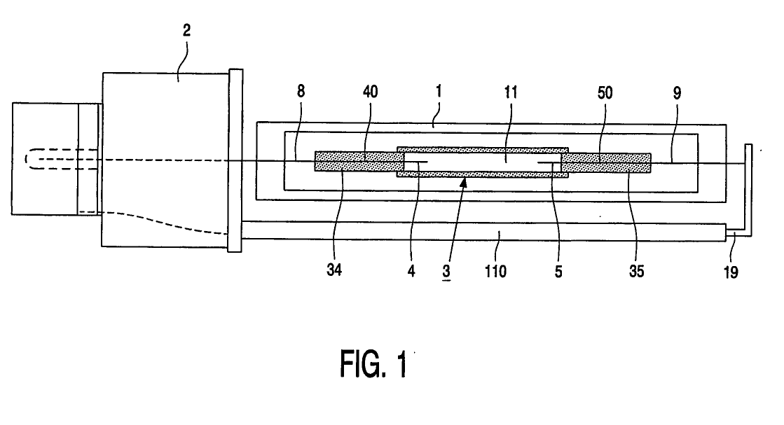

FIG. 1 shows a prior-art lamp in side elevation;

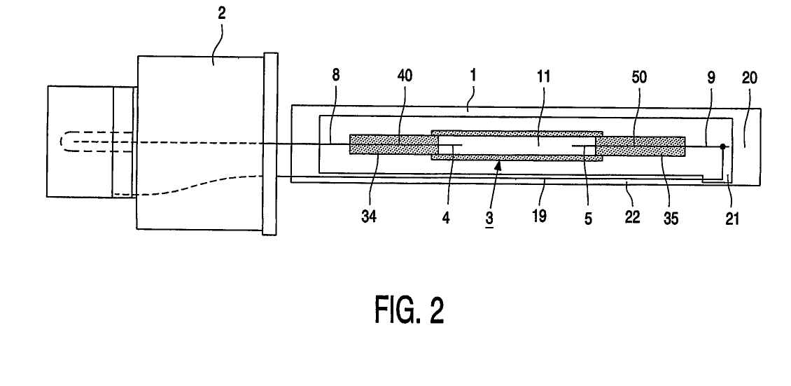

FIG. 2 shows a lamp according to the invention in side elevation;

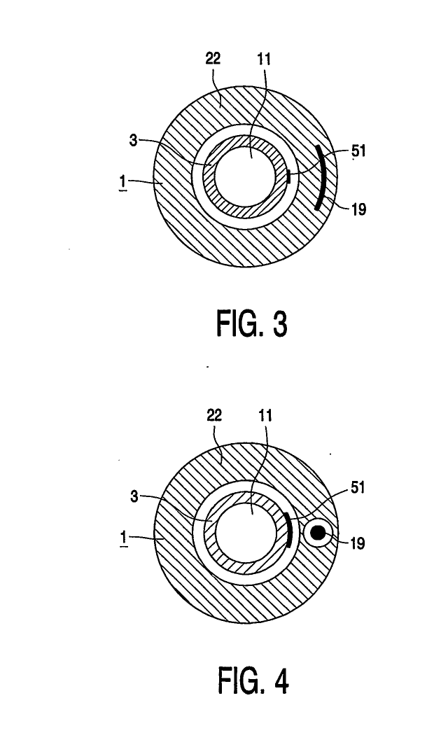

FIG. 3 shows a lamp according to FIG. 2 in cross-section; and

FIG. 4 shows an alternative lamp according to the invention in cross-section.

In FIG. 1 the electric discharge lamp has a tubular, light transmissive ceramic discharge vessel 3 of polycrystalline aluminum oxide, and a first and a second current conductor 40, 50 which enter the discharge vessel 3 opposite each other, and each conductor 40, 50 supports an electrode 4, 5 in the vessel 3. Said electrodes are made of tungsten and are welded to the current conductors 40, 50.

Ceramic seals 34, 35 seal the discharge vessel 3 around the current conductors 40, 50 in a gas tight manner. The discharge vessel 3 has an ionizable filling comprising xenon as a rare gas and a metal halide mixture comprising sodium and rare earth iodides. The discharge vessel 3 is surrounded by a substantial cylindrical transparent outer envelope 1.

The outer ends of current conductors 40, 50 are connected to connecting wires 8, 9 which extend outside the seals 34, 35 and through the end walls of outer envelope 1. One connecting wire 8 is connected directly to a first electric pole in mounting base 2, the other connecting wire 9 is connected to a lead back wire 19, which extends alongside the outer envelope 1 and is connected to a second electric pole in the mounting base 2. The lead back wire 19 is surrounded by a ceramic isolation shield 110.

In FIG. 2 the electric discharge lamp has a tubular, light transmissive ceramic discharge vessel 3 of polycrystalline aluminum oxide, and a first and a second current conductor 40, 50 which enter the discharge vessel 3 opposite each other, and each conductor 40, 50 supports an electrode 4, 5 in the vessel 3. Said electrodes are made of tungsten and are welded to the current conductors 40, 50.

Ceramic seals 34, 35 seal the discharge vessel 3 around the current conductors 40, 50 in a gas tight manner. The discharge vessel 3 has an ionizable filling comprising xenon as a rare gas and a metal halide mixture comprising sodium and rare earth iodides. The discharge vessel 3 is surrounded by a substantial cylindrical transparent outer envelope 1.

The outer ends of current conductors 40, 50 are connected to connecting wires 8, 9 which extend outside the seals 34, 35 and through the end walls of outer envelope 1. One connecting wire 8 is connected directly to a first electric pole in mounting base 2, the other connecting wire 9 is connected to a lead back wire 19, which extends through the cylindrical side wall 22 of the outer envelope 1 in a hollow channel and is connected to a second electric pole in the mounting base 2. According to FIG. 3 the lead back wire 19 is shaped and located such that it also acts as a start-up enhancing antenna, as well as a light-shielding strip.

In FIG. 4 a cross-section of an alternative lamp construction of a lamp according to the invention is shown, in which the function of light-shielding and antenna is separated from the lead-back conductor function of the lead-back wire 19. The light shielding and antenna function is provided by a separate strip 51.

During manufacturing of the lamp according to FIG. 2 the envelope 1 is left open at the side of end wall 20. A recess 21 is made in the wall 22 and a hollow channel is provided through the length of the wall 22. If the lead back 19 wire must act as an antenna, the hollow channel should preferably be located as close as possible to the inner side of the outer envelope. The lead back wire 19 is welded to connecting wire 9, and the discharge vessel 3 is then inserted in the envelope 1, while at the same time the lead back wire 19 is inserted in the bore hole in the wall 22. Finally, the end wall 20 is closed by locally melting the outer envelope.

1. A gas discharge lamp comprising an elongated discharge vessel (3) surrounded by an outer envelope (1) and having a wall which encloses a discharge space (11) containing an inert gas and an ionizable filling, wherein at both ends in said discharge space (11) an electrode (4, 5) is arranged between which a discharge arc can be maintained along a discharge path, wherein one end of the discharge vessel (3) is mounted in a mounting base (2), said lamp comprising a lead-back conductor (19) supplying current from the mounting base (2) to the electrode (5) at the other end of the discharge vessel (3), characterized in that, the lead-back conductor (19) extends through the length of the wall (22) of the outer envelope (1).

2. A lamp according to claim 1, wherein the lead-back conductor (19) is shaped such that it acts as an antenna.

3. A lamp according to claim 1, wherein the lead-back conductor (19) is located closer to the inner side of the outer envelope (1) than to the outer side.

4. A lamp according to claim 1, wherein the lead-back conductor (19) is shaped such that it acts as a light shielding strip.

5. A lamp according to claim 1, wherein a hollow channel is provided in the length of the wall (22) of the outer envelope (1) containing the lead-back conductor (19).

6. A lamp according to claim 5, wherein the hollow channel is provided with a dark or black light absorbing coating.

7. A lamp according to claim 1, wherein the lead-back conductor (19) is provided with a dark or black light absorbing coating.

8. A vehicle head lamp comprising a reflector and a gas discharge lamp according to claim 1 mounted therein.

9. Method for producing a gas discharge lamp wherein an elongated discharge vessel (3) having a wall which encloses a discharge space (11) containing an inert gas and an ionizable filling is provided, wherein at both ends in said discharge space (11) an electrode (4, 5) is arranged between which a discharge arc can be maintained along a discharge path, wherein a lead-back conductor (19) is provided for supplying current from a mounting base (2) wherein one end of the discharge vessel (3) will be mounted to the electrode (5) at the other end of the discharge vessel (3), wherein an outer envelope (1) is provided, wherein the electrode (5) at said other end of the discharge vessel (3) is connected to said lead-back connector (19), and wherein an outer envelope (1) is provided for surrounding said discharge vessel (3), characterized in that a hollow channel is provided in the length of the wall (22) of the outer envelope (1), and the lead-back conductor (19) is inserted in said hollow channel and the discharge vessel (3) is inserted in the outer envelope (1), after which the outer envelope is closed.
